(19) United States
(12) Patent Application Publication
(10) Pub. No.: US 2012/0136204 A1
(43) Pub. Date: May 31, 2012

(54) ENHANCED DEVICE FOR THE ARTIFICIAL INSEMINATION OF SHEEP, GOATS, DEER AND/OR DOMESTIC AND WILD ANIMALS

(76) Inventor: Marco Antonio Hidalgo-Mendoza, Colonia Narvarte Pte (MX)

(21) Appl. No.: 13/123,023

(22) PCT Filed: Oct. 5, 2009
(86) PCT No.: PCT/MX09/00107

§ 371 Date: Jun. 10, 2011

Related U.S. Application Data
(60) Provisional application No. 61/195,473, filed on Oct. 7, 2008.

(51) Int. Cl. A61D 19/02

(52) U.S. Cl. 600/38

(57) ABSTRACT

An artificial insemination device is formed by a semen-filled tube or tube at one end of a pipette with a syringe attached to the other end. A fitted insemination point is fitted to the free end of the semen-filled straw. The semen-filled tube is attached with the adjustable openings in the pipette and the fitted point, in such a way that the semen-filled tube of different diameters can be forced to adjust to the adjustable opening. The pipette-tube-point unit is inserted in the vagina of the animal using a speculum until the tip with one or more folds, one or more openings and a spherical sealing mechanism, enters the cervix and forms a seal between the tip and cervix. The syringe, which contains the diluent, is pressed to force the semen and the diluent fluid toward at least one ejection outlet in the tip and out toward the uterus of the animal. Optimum quantities of semen and diluent fluid may be provided for different animals.

### FIELD OF THE INVENTION

The present invention relates to the artificial insemination of animals, more particularly, to an enhanced device for the artificial insemination of sheep, goats, deer and other exotic and wild animals, with an elevated conception rate.

### BACKGROUND OF THE INVENTION

Artificial insemination of cattle is a common practice and studies and research have been carried out that confirm the benefits, among others, of greater rates conception. Most of the devices currently in use include a general syringe design containing a semen reservoir. The syringe is inserted in the reproductive tract of the animal to deposit the semen to ensure greater reproductive success.

An aim of artificial insemination is related to the capacity of selecting and ensuring the delivery of superior genetic characteristics, and improving pregnancy success rates. The pregnancy efficiency levels are critical because they are directly related to the cost of cattle breeding. A factor that affects the pregnancy efficiency levels is also related closely to the device and the artificial insemination technique used.

In the state of the technique there is a device for artificial insemination, as described in Mexican Patent No. 154491 issued to Marco Antonio Hidalgo and Malcolm Niven, on 3 Jul. 1987, called “Device to facilitate the artificial insemination of cows”. This patent is incorporated in the present patent for reference. The aforementioned document represents the state of the technique closest to the present invention.

Traditionally, the artificial insemination technique in cattle has been practiced by introducing the Semen using an applicator that has a tube or straw-like reservoir attached to the end that is introduced into the vagina. The entrance to the cervix is located first; next, the applicator with the semen-filled tube is introduced into and through the vagina to the cervix entrance and the semen is deposited there by pressing a metal plunger that simultaneously presses a plug inside the semen-filled tube to expel the semen from the tube toward the uterus.

However, the cervix in species of animals such as sheep, goats, deer and/or other wild and exotic animals is irregularly shaped with many folds that do not allow easy access to the uterus. As a result, only fresh semen can be applied with large concentrations of sperm, such as, for example, 200 to 400 million spermatozoids. An additional inconvenience that this type of artificial insemination presents is that the semen only reaches the entrance to the cervix, which is not effective for insemination with frozen semen. Furthermore, the spermatozoids lose strength before reaching the ovule for fecundation and as a result the effectiveness is low.

For the artificial insemination of sheep with frozen sperm there is only a Laparoscopy apparatus, which requires perforating a side of the abdomen of a sheep to inflate the abdominal cavity with air to be able to introduce the device that permits visualizing and locating the uterine tubes. Following this procedure, the other side of the abdomen is perforated to introduce the artificial insemination device. This apparatus has a needle that is introduced through the abdominal cavity to the uterus where it will deposit the semen. Unfortunately, this method has the disadvantage of being costly and invasive, and also adds the risk of SCARPIE transmission (the same microorganism of mad cows). Moreover, the laparoscopy method requires highly qualified staff.

Consequently, there still exists a need for an enhanced mechanism for artificial insemination of sheep, goats, deer and/or other exotic and wild animals that can overcome the disadvantages and inconveniences of the state of the technique, and that can be used with fresh or frozen semen, offer an elevated conception success rate and is easy to use.

The purpose of the present invention is to provide enhancements in a device for the artificial insemination of sheep, goats, deer, and/or other wide and exotic animals, to make it highly effective so there are greater conception rates, thus reducing the Costs associated with cattle breeding.

It is also the purpose of the present invention to provide enhancements in the device for the artificial insemination of sheep, goats, deer and/or other wide and exotic animals that is low cost and easy to use and does not require highly qualified staff or complex insemination techniques.

The advantages of the present invention arise from the use of a device for the artificial insemination of sheep, goats, deer and/or other exotic and wild animals, which includes a universal pipette for special insemination for any presentation of semen and a syringe fitted to one end of the pipette. This syringe is a means for adding pressure to the insemination pipette that has a semen-filled tube attached to the other end. According to the principles of the present invention a semen ejection point is attached and covers the front end of the insemination pipette.

This device includes a rigid tube of appropriate length and diameter that prevents semen residue from adhering to the walls of the universal pipette from the effect of forcing the ejected liquid. The pipette advances through this tube, which has a cannula-shaped mechanism at the other end made of metal or plastic, that is either straight or has folds, and with one or more outlets for the rapid ejection of semen toward the uterus. This last device also has an almost spherical seal on the end that allows the device to pass through to the uterus without causing damage.

### BRIEF DESCRIPTION OF THE DRAWINGS

The features that are considered characteristic of the present invention are established in detail in the attached Claims. However, the invention itself, its organizational and operational method, together with other objects and advantages of the device, will be better understood in the following description of certain modalities, when read in relation to the drawings attached, in which:

FIG. 1 is a lateral; partial view that shows the pipette-tube-point unit of the previous technique.

FIG. 2 is a lateral view showing the insemination unit during the application of the diluent fluid to the pipette shown in FIG. 1.

FIG. 3 is a lateral view of a the semen ejection point of the device for the artificial insemination of sheep, goats, deer and other exotic and wild animals, of the present invention.

FIG. 4 is a side view of a cross section of the semen ejection point of the present invention shown in FIG. 3.

FIG. 5 is a cress section view of the semen ejection point of the present invention shown in FIG. 3.

FIG. 6 is a side view of the attachable portion of the pipette of the insemination point of the present invention.

### DETAILED DESCRIPTION OF THE INVENTION

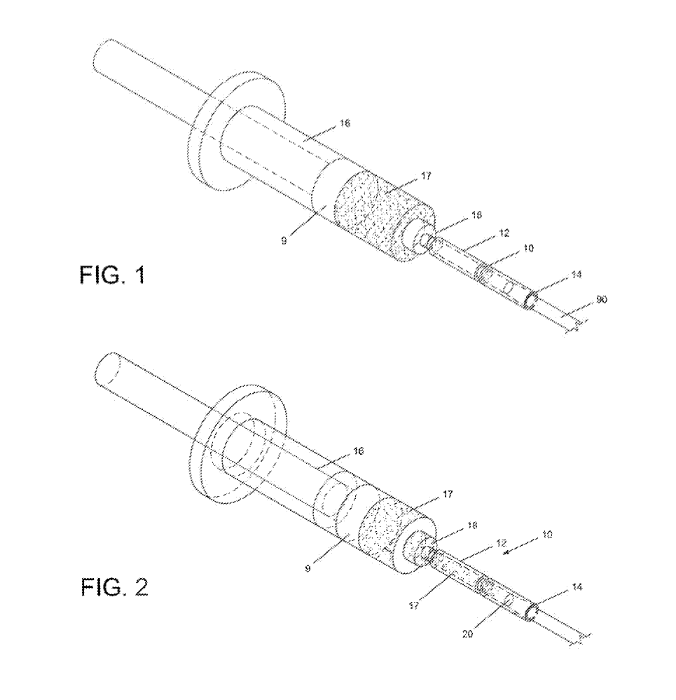

FIGS. 1 and 2 show an artificial insemination unit that generally includes a universal pipette (10) with an anterior end (12) and posterior end (14). The universal pipette (10) is designed to accommodate any presentation of semen that is currently on the market. The anterior end (12) is connected in fluid communication with a syringe (16), which contains a diluent (17) of semen. The syringe (16) includes an interior plunger (9) and an opening to expel the diluent (17) from the syringe (16) to the pipette (10). The anterior end (12) of the pipette (10) includes a syringe adaptor (18). The maximum volume of the diluent fluid that can be injected into the pipette (10) varies approximately from 2 to 4 cm³. The interior of the posterior end (14) of the pipette (10) has a conic-shaped portion (20) to adjustably fit any type of semen-filled tube (shown in dotted lines).

As shown particularly in FIG. 2, once the syringe is inserted (16) in the adaptor (18) of the anterior end (12) of the pipette (10), the plunger (9) of the syringe (16) is pressed forward to push through the appropriate amount of the diluting solution, which may be 2.9% sodium citrate (17), from the syringe (16) into the pipette (10), in such a way that the diluting solution moves through the pipette (10) but does not reach the internal conic portion (20) of the posterior end (14).

A semen-filled tube is cut off at one end and inserted firmly in the posterior end (14) of the pipette (10), in such a way that the cut-off end of the tube butts against the inner conic portion (20) of the posterior end (14) and remains fixed to the posterior end (14). In addition, the free end of the tube is cut off so that an insemination point of the present invention may be attached.

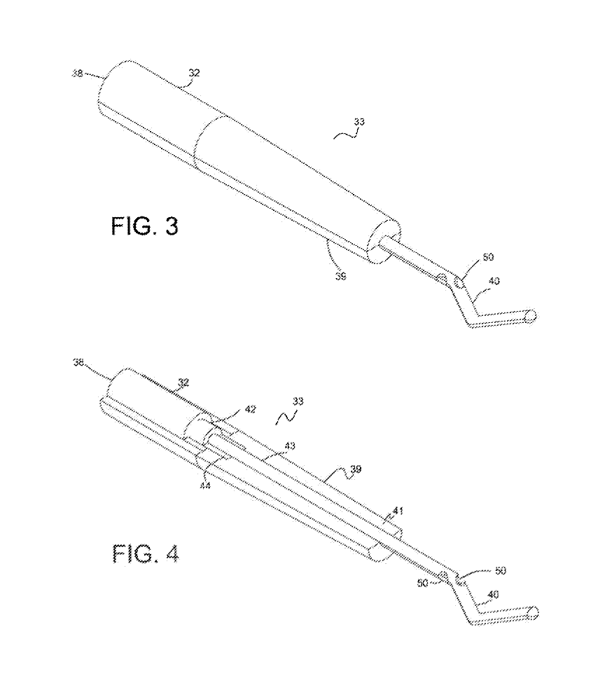

As FIGS. 3 to 6 in particular show, the attachable insemination point includes a pipette coupler portion (31) and a semen ejection tip (33).

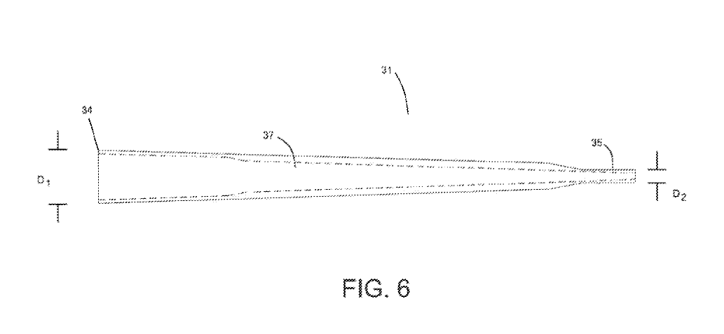

As FIG. 6 in particular shows, the coupler portion of the pipette (31) has an anterior end (34) and a posterior end (35). The coupler portion of the pipette (31) is a long rigid tube with a D₁ diameter at the anterior end (34) that allows the insertion of the posterior end (14) of the pipette, (10). The interior of the coupler portion (31) includes a annular ridge (37) that serves as a stop to define the maximum distance to which the posterior end (14) of the pipette (10) can advance inside the coupler portion (31), thus facilitating the grip and immobilization of the pipette inside the anterior end (34). Preferably, the coupler portion of the pipette (31) has. length such that the tube of semen (not illustrated) inserted in the posterior end (14) of the pipette(10) can advance inside the tubular body of the coupler portion of the pipette (31) and be lodged and protected by this coupler portion (31). The diameter D₁ of the anterior end (34) of the coupler portion of the pipette (31) gradually narrows as it approaches the posterior end (35), where the D₂ diameter of the posterior end (35) is less than the D₁ diameter of the anterior end (34) to be able to attach and adjust the semen ejection tip (33) of the insemination point of the present invention as described below. The length and diameter of the coupler portion of the pipette (31) are chosen in a manner as to prevent residuals from adhering to the walls of the universal pipette from the effect of the ejected liquid being pushed, through.

FIGS. 3 to 5 show the semen ejection point (33) in relation to a modality of the present invention. The semen ejection point (33) encompasses a hollow cylindrical section (32) with a receiving end (38) that generally remains open for the insertion of the posterior end (35) of the coupler portion of the pipette (31). Preferably, the semen ejection point (33) also has a conical frustum-shaped section (39) immediately next to the hollow cylindrical section (32): In a preferred modality, the hollow cylindrical section (32) and the solid conical frustum-shaped section (39) of the semen ejection point (33) are made up of a single piece of plastic or thermoplastic material, although they can be made with other types of appropriate materials.

The solid conical frustum-shaped section (39) includes a central orifice (41) sized to fit a tip or cannula (40) for ejecting semen. The central orifice (41) extends axially through the extended section of the solid conical-frustum-shaped section (39) for fluid communication to the hollow cylindrical section (32) and the tip or cannula. (40) to help guide the semen from the semen-filled tube (not shown) inserted in the pipette (10) and lodged inside the coupler portion of the pipette (31) toward the tip or cannula (40).

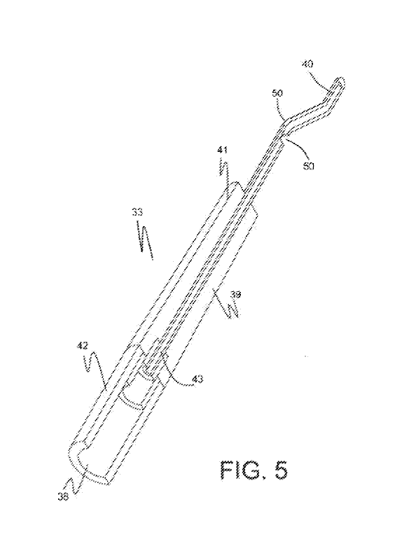

FIGS. 4 and 5 show that the semen ejection point (33) also includes a sleeve (42) placed inside the hollow cylindrical section (32), which butts up against the solid conical frustum-shaped section (39). Preferably, the sleeve (42) has a portion (43) extending a certain distance toward the central orifice (41) of the solid conical frustum-shaped section (39), where the conical frustum-shaped section (39) also presents a reduced radial portion (44) or a greater diameter to accommodate the portion (43) of the sleeve (42).

The tip or cannula (40) of the semen ejection point (33) is preferably a thin plastic or metal cannula that may be straight or have folds. In a cannula with folds, the angles can vary between 105° and 140° in each fold. In addition, the tip or cannula (40) also includes one or several outlets (50) that permit the quick ejection of the semen toward the uterus. In a modality such as the one shown in FIGS. 3 to 5, the tip or cannula (40) has at least two outlets (50) placed in opposite directions near one of the folds formed in the tip or cannula (40). The placement of the outlets (50) in the tip (40) allows the semen—diluent mixture to be expelled in opposite directions inside the cervix. The tip or cannula (40) also includes a blunted tip end (91) at a distance from the two outlets (50) that help to create a space between the folds of the cervix to allow the semen—diluent mixture to flow through to the cervix more easily. Preferably, the blunted tip end (91) is rounded so that it does not damage the folds of the cervix.

The entire assembled unit of the artificial insemination device uses a speculum that is introduced into the vagina of the animal. The speculum is a tube that helps to locate the entrance to the cervix. Once the cervix is located, the pipette with the semen-filled tube and insemination point is introduced. The insemination point has a rigid sheath with a thin metal or plastic cannula inside that is either straight or has folds in the penetrating tip, which presses against the uterus. Next, the pipette containing the diluent fluid is discharged, and the diluent fluid is forced toward the semen-filled tube, resulting in the discharge of semen from the tube. The syringe attached to the opposite end of the pipette is the part of the device that presses the diluent fluid coward the semen, forcing it to reach the uterus without returning to the vagina.

While a certain modality of the, invention has been illustrated and described, emphasis must be placed on the fact that many modifications are possible. The present invention, therefore, must not be restricted except by the demands of the previously-mentioned technique and the spirit of the attached claims.

1. A device for the artificial insemination of sheep, goats, deer and other domestic, exotic and wild animals, that includes a:
pipette with an anterior end and a posterior end;
syringe containing a semen diluent in fluid communication with the posterior end of the pipette, the syringe having a plunger and an aperture to expel the diluent fluid toward and through the pipette;
semen-filled tube, open at both ends, with one end connected to the posterior end of the pipette.
the device is characterized for artificial insemination by comprising:
an insemination point member adapted to receive the second end of the semen-filled tube, wherein the insemination point member comprises a pipette-coupler portion and semen-ejection tip with one or several folds, wherein the semen ejection tip includes at least one ejection outlet and a blunted spherically-shaped end that allows the passage of the ejection point through the cervix, which is irregularly-shaped and has many folds, to the uterus, without causing injury.

2. The insemination device in accordance with claim 1 is further characterized by the coupler portion of the pipette, which is a long rigid tube with two ends: an anterior end and a posterior end. The anterior end has a D1 diameter to allow the insertion of the posterior end of the pipette. The posterior end of the coupler has a D2 diameter to fit and adjust the semen-ejection tip of the insemination point, where the D2 diameter is less than the D1 diameter.

3. The insemination device in accordance with claim 2 is further characterized by the D1 diameter of the anterior end of the coupler portion of the pipette, which narrows gradually toward to the posterior end with a D2 diameter.

4. The insemination device in accordance with claim 2, is further characterized by the coupler portion that contains an inside annular ridge that functions as a stop that defines the maximum distance that the inserted end of the pipette can advance, and that is used to attach and immobilize the pipette inside the anterior end.

5. The insemination device in accordance with claim 1, is further characterized by a coupler portion of the pipette with a proper length to lodge and completely protect the semen-filled tube.

6. The insemination device in accordance with claim 1 is further characterized by a semen ejection point that includes a hollow cylindrical section with a generally open receiving end for the insertion of the posterior end of the coupler portion of the pipette.

7. The insemination device in accordance to claim 6 is further characterized by the semen ejection point that includes a solid conical frustum-shaped section immediately adjacent to the hollow cylindrical section. The solid conical frustum-shaped section includes a central opening sized to fit a semen-ejection tip or cannula.

8. The insemination device in accordance with claim 6 is further characterised by the hollow cylindrical section and the solid conical frustum-shaped section of the semen-ejection tip, which form one single piece made of plastic or thermoplastic material.

9. The insemination device in accordance with claim 7 is further characterized by the central opening extending axially through the solid conical frustum-shaped section for fluid communication to the hollow cylindrical section and the tip or cannula, to help guide the semen from the semen-filled tube inserted in the pipette and lodged inside the coupler portion of the pipette toward the tip or cannula.

10. The insemination device in accordance with claim 6, is further characterized by the semen ejection point, which includes a sleeve placed inside the hollow cylindrical section that butts against with the solid conical frustum-shaped section, where the sleeve has a portion that advances a certain distance toward the central opening of the solid conical frustum-shaped section, solid conical frustum section has a lesser radial portion or a larger diameter to accommodate the sleeve portion.

11. The insemination device in accordance with claim 1 is further characterized by the semen ejection tip, which is a thin cannula with folds and angles that vary between 105° and 140° between each fold.

12. The insemination device in accordance with the claim 1, is further characterized by the semen-ejection tip is a cannula having at least a pair of outlets placed in opposing direction and near one of the folds of the tip or cannula, wherein the opposite disposition of the pair of outlets allow the semen-diluent mixture to be expelled in opposite directions toward the cervix through the uterus.
